(19) United States
(12) Patent Application Publication
(10) Pub. No.: US 2019/0191695 A1
(43) Pub. Date: Jun. 27, 2019

(54) DISSOLVENT COMPOSITION, STABLE UNDER COLD CONDITIONS

(71) Applicant: OLEON NV, Evergem (BE)

(72) Inventors: Sophie DEPREY, Margny-Les-Compiegne (FR); Pierre RAVIER, Compiegne (FR)

(21) Appl. No.: 16/329,033

(22) PCT Filed: Aug. 30, 2017
(86) PCT No.: PCT/EP2017/071750

§ 371 Date: Feb. 27, 2019

(30) Foreign Application Priority Data
Aug. 30, 2016 (FR) 1658053

(51) Int. Cl. A01N 25/02; C11D 7/50

(52) U.S. Cl. CPC A01N 25/02; C11D 7/5009; C11D 7/5022

(57) ABSTRACT

A composition comprising: —at least 25% of a fatty acid methyl ester having from 6 to 14 carbon atoms, or a mixture of such methyl esters; —at least 15% of dimethyl sulfoxide, or DMSO; and —at least 5% of a glyceryl fatty acid monoester having from 6 to 14 carbon atoms or a mixture of such glyceryl monoesters; the percentages being percentages by weight relative to the total weight of the composition. This composition is stable at low temperature and may be used as a cleaning, dissolvent, dispersant and/or diluent composition, especially for active principles in the plant protections field.

### FIELD OF THE INVENTION

The present invention relates to a composition allowing the cleaning, dispersion, disintegration, solubilization and/or dissolution, partial or total, at a low temperature of substances that are only a little, or not at all, hydrophilic, and in particular phytosanitary active ingredients or polyurethane, as well as the use thereof at a low temperature.

### PRIOR ART

Dimethyl sulfoxide (DMSO), is a compound of empirical formula (CH₃)₂SO, having a molecular weight of 78.13 g/mol and CAS number: 67-68-5. This highly polar compound is a solvent of various organic polymers and resins and can be used to clean up residues of paints or of styrene copolymers. However, its high crystallization point (18° C.) means that it is a difficult compound to handle and store.

In order to overcome this problem, it is known to use N-methyl-2-pyrrolidone or 1-methyl-2-pyrrolidone (NMP: a cyclic amide (lactam) often used as a very fluid organic solvent, liquid at 0° C.), which offers a better toxicological profile.

It is also known to use mixtures of solvents. For example, Rhodiasolv® PolarClean is a mixture of ester amide and diamide. This solvent is liquid at 0° C. and is used in the formulation of phytopharmaceutical products (or plant protection products) for solubilizing phytosanitary active ingredients. However, these amides and mixtures of amides also have a not insignificant toxicity, which is detrimental to use thereof.

### GENERAL DESCRIPTION OF THE INVENTION

The purpose of the invention is to formulate a mixture, or premix, of solvents, liquid at 0° C. at least and possibly having an improved toxicological profile.

One of the objects of the invention is therefore a composition comprising:
at least 25% of a methyl ester of a fatty acid having from 6 to 14 carbon atoms, or a mixture of such methyl esters;
at least 15% of dimethyl sulfoxide, or DMSO; and
at least 5% of a glyceryl monoester of a fatty acid having from 6 to 14 carbon atoms, or a mixture of such glyceryl monoesters;
   the percentages being by mass with respect to the total mass of the composition.

A fatty acid methyl ester is a methyl alkanoate with an aliphatic chain, said chain being able to be branched or linear, saturated or unsaturated. The fatty acids are preferably of vegetable/animal origin. They can originate for example from palm, copra, palm kernel or sunflower oils.

The fatty acid methyl ester is preferably a monoester. The fatty acid is preferably saturated. It can however be polyunsaturated, and in particular mono- bi- or tri-unsaturated.

C8 and C10 fatty acid methyl esters (i.e. those the fatty acids of which comprise 8 or 10 carbon atoms) have shown a particular synergy in combination with DMSO. Similarly, C6 methyl esters have also shown particular properties when combined with DMSO. Alternatively, C12 and C14 fatty acid esters can also be used. The same applies to C7, C9, C11, C13 and C15 esters. The relative concentration by mass of the C8-C10 methyl esters with respect to the other esters can advantageously be greater than 75%, preferably 85%. Mixtures of methyl esters, such as Radia 7983 or methyl cocoate, are particularly suitable for the composition according to the invention.

The fatty acid methyl esters can be used pure or in mixtures in the composition. Thus, a mixture of esters comprising, or consisting essentially of, C8 and C10 methyl esters, optionally in combination with one or more C6 methyl esters, can result in a composition having a high dissolving power. However, the relative concentration by mass of the C6 fatty acid methyl esters with respect to the other methyl esters is advantageously less than or equal to 10%, preferably less than or equal to 5%, for example from 1 to 5%. Such a mixture can be a product of natural origin and can therefore contain a low proportion of other esters, for example C6 (<1%) or C12 (<2%).

The fatty acid of the fatty acid methyl ester can also comprise, or have, from 8 to 12 carbon atoms, preferably from 8 to 10 carbon atoms.

The proportion of the fatty acid methyl ester or of the mixture of fatty acid methyl esters in the composition is preferably at least 27%, 35%, 40%, 45%, 50%, 55% or 60% by mass with respect to the total mass of the composition.

Alternatively, the proportion of the fatty acid methyl ester or of the mixture of fatty acid methyl esters is preferably at most 25%, 27%, 35%, 40%, 45%, 50%, 55%, 60% or 70% by mass with respect to the total mass of the composition.

The proportion of methyl ester(s) can thus range from 25% to 70%, from 25% to 80%, from 30% to 60%, and/or from 40 to 50%.

The proportion of DMSO is preferably at most 75%, 70%, 65%, 60%, 55%, 50%, 45% 40% or 35% by mass with respect to the total mass of the composition. Alternatively, the proportion of DMSO is preferably at least 17%, 20%, 35%, 40%, 45% 50% or 55% by mass with respect to the total mass of the composition.

The proportion of DMSO comprised in the mixture can thus vary from 15% to 65%, from 17% to 60%, from 20% to 50%, and/or from 15 to 45%.

A fatty acid glyceryl monoester is a glyceryl monoalkanoate with an aliphatic chain, said chain being able to be branched or linear, saturated or unsaturated. The fatty acids are preferably of vegetable/animal origin. They can originate for example from palm, copra, palm kernel or sunflower oils. Preferably, they originate from palm kernel oil.

The fatty acid is preferably saturated.

Glyceryl esters of C8, C10 and C12 fatty acids (i.e. those the fatty acids of which comprise 8, 10 or 12 carbon atoms) have shown a particular synergy for allowing a homogenous liquid phase to be maintained at 0° C. Alternatively, glyceryl (or glycerol) monoesters of C6 and C14 fatty acids can also be used. The same applies to C7, C9, C11, and C13 esters. When mixtures of C8-C10 glyceryl monoester are used, the relative concentration by mass of the C8-C10 esters with respect to the other esters can advantageously be greater than 85%, preferably 90%. Glyceryl caprylate and glyceryl laurate, as well as a glyceryl caprylate/caprate mixture are preferred ingredients for the composition according to the invention. The proportion by weight of caprylate/caprate can be approximately 3/1.

When a mixture of glycerol monoesters is used, the relative concentration by weight of the C6 fatty acid glycerol esters with respect to the other methyl esters is advantageously less than or equal to 10%, preferably less than or equal to 5%, for example from 1 to 5%. Such a mixture can be a product of natural origin and can therefore contain a low proportion of other compounds, for example less than 15% by mass, or even less than 10% by mass.

The proportion of the fatty acid glycerol monoester or of the mixture of glycerol fatty acid monoesters in the composition is preferably at least 7%, 8%, 10%, 13%, 15%, 17%, 20%, 25% or 50% by mass with respect to the total mass of the composition.

A concentration of more than 10% by mass of glycerol ester is particularly preferred.

Alternatively, the proportion of the glycerol fatty acid monoester or of the mixture of glycerol monoesters is preferably at most 15%, 20%, 25%, 30%, 40%, 45%, 50%, 55% or 60% by mass with respect to the total mass of the composition.

The proportion of glyceryl monoester(s) can thus range from 5% to 60%, from 8% to 60%, and/or from 10% to 30%, by mass with respect to the total mass of the composition.

According to a preferred variant of the invention, the mass concentration ratio between the DMSO and the fatty acid methyl ester in the composition can vary from 1 to 0.5. According to another variant of the invention, the composition can further comprise monopropylene glycol (for example from 0.01 to 30% by mass), triacetin (0.01% to 30%) and/or one or more succinate esters such as diisoamyl succinate (for example from 0.01 to 40% by mass). The proportions are indicated with respect to the total mass of the composition.

According to a preferential variant of the invention, the composition comprises by mass, with respect to the total mass of the composition, at least 5% of monopropylene glycol, more preferentially at least 10%, and even more preferentially at least 15% of monopropylene glycol.

The addition of monopropylene glycol makes it possible to reduce the quantity of glyceryl monoester (for example by 5% of the total mass of the composition).

According to a preferred embodiment, the composition according to the invention contains essentially (i.e. at 90%, preferably 95% by mass, or even 99%) only DMSO, at least one fatty acid methyl ester, or a mixture of such esters and at least one glycerol fatty acid monoester, or a mixture of such monoesters.

Such a composition can however optionally also comprise a compound selected from the group constituted by glycerol diacetate monolaurate, glycerol acetate dilaurate, dimethyl isosorbide ester (DMI) (CAS No. 93920-28-6/RADIA 7926, OLEON) and isosteramide (a mixture of laurylamide DEA (CAS No. 92680-75-6, Antaichem) and cocamide DEA (CAS No. 68603-42-9; CHEMOS)) and mixtures thereof. The proportion by mass of this compound with respect to the total mass of the composition according to the invention may be at least 5%, preferably at least 10%, or may vary from 0.01 to 30%.

The composition according to the invention can advantageously be used for the dispersion, dilution, and in particular the solvation of an active compound or mixture thereof. This use as well as a method of dilution and in particular a method of solvation comprising a step of mixing with an active compound also forms part of the invention. Thus an object of the invention is an active composition comprising a composition as described above and also comprising an active compound in solution. In this case the proportions of such a composition according to the invention are to be measured excluding the active compound or compounds. The dissolved active compound can constitute by mass from 5 to 40% of the active composition.

By “active compound” is meant in particular a phytosanitary product, a phytopharmaceutical product, a pesticide, a herbicide (for example a compound from the family of the pyridyl-phenyl ethers), a fungicide, an insecticide and/or a biopesticide.

For example, this active compound can be selected from the group constituted by the fungicides: difenoconazole, epoxiconazole, triadimefon, chlorphyrifos and cinnamaldehyde; the herbicides: diclofop, quizalofop-p-ethyl, propanil, a pyridyl-phenyl ether such as clodinafop propargyl, pendimethalin, pinoxaden, oxyfluorfen and trifluralin; the insecticide propoxur; the biopesticides like bacteria such as Bacillus thuringiensis (Bt) and/or Bt toxin, or Bacillus subtilis, entomopathogenic fungi such as Beauveria bassiana, Lecanicillium spp., Metarhizium spp., insect pheromones, as well as any other substance emitted by an insect, products originating from fermentation, such as for example the insecticide active ingredient Spinosad and chitosan.

The active compound can also be selected from the group of the minerals of natural origin, such as sodium bicarbonate, diatomaceous earths, potassium silicate. More generally, the term “active compound” extends to any natural product derived from a plant and/or from plant extracts, such as alkaloids, terpenoids, phenolic derivatives, vegetable oils (rapeseed oil, neem oil), fatty acids, essential oils (geraniol, thymol) etc.

The active composition is particularly preferably stable at low temperatures, for example at 0° C. Preferably, such a stable composition is liquid, single-phase and optionally transparent at this temperature. Thus the invention also relates to a method for stabilizing compositions comprising active ingredients at temperatures ranging from 5 to 10° C., preferably from 0 to 25° C. and even from −5° C. to 30° C.

Another subject of the invention is the use of a composition as described above as a cleaning agent, in particular as a cleaning agent for polyurethane foams. This subject extends to a cleaning method comprising applying the composition according to the invention to a surface soiled by an organic compound, such as a polyurethane-based compound, optionally followed by a step of mixing and removing said mixture from said surface.

Another object of the invention also extends to a method for producing a composition and/or an active composition as described in the present application. This method comprises in particular a step of mixing DMSO with said one or more fatty acid methyl ester(s) and said one or more fatty acid glyceryl monoester(s). Optionally, the method also comprises mixing the other compounds, active ingredients or others described in the application.

Other embodiments will become apparent on reading the following Examples, which are described in order to better explain the invention.

### EXAMPLE 1: DISPERSANT COMPOSITIONS ACCORDING TO THE INVENTION AND COMPARISON WITH OTHER COMPOSITIONS

### Materials and Methods:

The products used are:
DMSO (technical grade—Arkema)
Mixture of 06-C10 fatty acid methyl esters (CAS No. 68937-83-7), marketed under the reference RADIA 7983 by OLEON. This mixture comprises from 98.5% to 100% of fatty acid methyl esters. It comprises from 48 to 70% of C8 fatty acid methyl esters (CAS No. 85566-26-3), from 30 to 50% of C10 fatty acid methyl esters (CE No: 287-636-4), at least 4.5% of C6 fatty acid methyl esters and 2% or less of C12 fatty acid methyl esters.
Mixture of coconut oil methyl esters (CAS No. 67762-40-7), or methyl cocoate, marketed under the reference RADIA 7112 by OLEON and comprising the following proportions by mass of methyl esters, with respect to the total mass of the mixture: C12=74.6%, 014=24.4%, 016=0.7% and others=0.3%.
Radia 7907 product of vegetable origin marketed by OLEON and comprising a minimum of 85% of glyceryl monoester and a minimum of 85% of glyceryl caprylate (CAS No. 26402-26-6). After analysis, the product used contains 85.9% by mass of glyceride monoesters, of which 98% is glyceryl caprylate.
Palm kernel oil glyceryl monoesters, or PKOGM, (CAS No. 27215-38-4) having the following composition, by mass, Glycerol: 1%; C6 monoglycerides: 0.3%; C8 monoglycerides: 6.1%; C10 monoglycerides: 9.4%; C12 monoglycerides: 67.1%, C14 monoglycerides: 10.8%; C16 monoglycerides: 1.6%; C18 monoglycerides: 0.2%; C8-C8 diglyceride: 0.2%; C8-C10 diglyceride: 0.3%; C10-C10 diglyceride: 1.6%; C10-C12 diglyceride: 0.3%; C12-C12 diglyceride: 0.4%; C12-C14 diglyceride: 0.1%; other compounds 0.6%. BALANCE: Glycerol: 1%; monoglycerides: 95.5%; (C6-C14 monoglycerides: 93.7%) and diglycerides: 3%,
Diisoamyl succinate (Cas No. 818-04-2) purity: 90% by mass (isoamylic alcohol forms part of the residual compounds—obtained from OLEON).

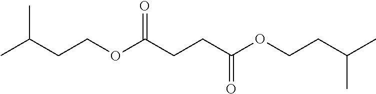 [SMILES: CC(C)CCOC(=O)CCC(=O)OCCC(C)C]

Monopropylene glycol (MPG) of plant origin (marketed under the reference RADIANOL™ 4713 by OLEON, purity ≥99.5% by mass).

Note: The percentages expressed are by mass with respect to the total mass of the composition.

TABLE I
Proportions of the components of compositions 1 to 12 as a percentage
by mass with respect to the total mass of the composition.

| Compositions | 1 | 2 | 3 | 4 | 5 | 6 | 7 | 8 | 9 | 10 | 11 | 12 |
|---|---|---|---|---|---|---|---|---|---|---|---|---|
| DMSO | 50% | 40%, | 40% | 40% | 40% | 40% | 40% | 40% | 40% | 40% | 40% | 40% |
| Monopropylene glycol | | 20%, | | 10% | 15% | 5% | | 20% | | 10% | 15% | 5% |
| Radia 7983 | 50% | 40%, | 40% | 40% | 40% | 40% | | | 40% | 40% | 40% | 40% |
| Radia 7907 (incl. | | | 20% | 10% | 5% | 15% | 20% | | | | | |
| glyceryl caprylate) | | | | | | | | | | | | |
| Radia 7112 | | | | | | | 40% | 40% | | | | |
| PKOGM | | | | | | | | | 20% | 10% | 5% | 15% |

The equipment used is:
15 mL flasks
A refrigerated cabinet at 0° C. (Panasonic—MR-154-PE)
3 mL pipettes
An analytical balance (OHAUS Adventurer Pro AV264C)

### Procedure

A 15 mL flask is placed on the analytical balance. Each component is added in the proportions indicated in Table I.

For composition 1, 5 g of DMSO and 5 g of RADIA™ 7983 are added to the flask.

For composition 2, 4 g of DMSO, 2 g of RADIANOL™ 4713, 4 g of RADIA™ 7983 are added to the flask.

For composition 3, 4 g of DMSO, 4 g of RADIA™ 7983 and 2 g of RADIA™ 7907 are added to the flask.

For composition 4, 4 g of DMSO, 1 g of RADIANOL™ 4713, 3 g of RADIA™ 7983 and 1 g of RADIA 7907 are added to the flask.

For composition 5, 4 g of DMSO, 1.5 g of RADIANOL™ 4713, 4 g of RADIA™ 7983 and 0.5 g of RADIA 7907 are added to the flask.

For composition 6, 4 g of DMSO, 0.5 g of RADIANOL™ 4713, 4 g of RADIA™ 7983 and 1.5 g of RADIA 7907 are added to the flask.

For composition 7, 4 g of DMSO, 4 g of RADIA™ 7112 and 2 g of RADIA™ 7907 are added to the flask.

For composition 8, 4 g of DMSO, 2 g of RADIANOL™ 4713, 4 g of RADIA™ 7112 are added to the flask.

For composition 9, 4 g of DMSO, 4 g of RADIA™ 7983 and 2 g of PKOGM are added to the flask.

For composition 10, 4 g of DMSO, 1 g of RADIANOL™ 4713, 4 g of RADIA 7983 and 1 g of PKOGM are added to the flask.

For composition 11, 4 g of DMSO, 1.5 g of RADIANOL™ 4713, 4 g of RADIA 7983 and 0.5 g of PKOGM are added to the flask.

For composition 12, 4 g of DMSO, 0.5 g of RADIANOL™ 4713, 3 g of RADIA 7983 and 1.5 g of PKOGM are added to the flask.

Once these additions have been carried out, the flask is closed and agitated by hand for several seconds in order to obtain a homogenous mixture. According to the recommendations of standard CIPAC MT39 (2009) for assessing the stability of phytosanitary products at 0° C., a sample is then placed in the refrigerated cabinet at 0° C., and another is placed at ambient temperature. After 7 days' rest, the flasks are inspected.

TABLE II
Results:

| Composition | 1 | 2 | 3 | 4 | 5 | 6 | 7 | 8 |
|---|---|---|---|---|---|---|---|---|
| Appearance at | Clear | 2 | Clear | Clear | Clear | Clear | Clear | 2 |
| ambient T ° | liquid | phases | liquid | liquid | liquid | liquid | liquid | phases |
| Appearance | 2 | / | Clear | Clear | 2 | Clear | Clear | / |
| at 0° C. | phases | | liquid | liquid | phases | liquid | liquid | |

| Composition | 9 | 10 | 11 | 12 |
|---|---|---|---|---|
| Appearance at | Clear | Clear | Clear | Clear |
| ambient T ° | liquid | liquid | liquid | liquid |
| Appearance | Clear | Clear | Clear | Clear |
| at 0° C. | liquid | liquid | liquid | liquid |

The fact of mixing DMSO with a methyl ester does not give a mixture that is stable at 0° C., even with the addition of a polyol such as monopropylene glycol. Conversely, the addition of a glyceryl monoester (compositions according to the invention 3, 4, 6, 7 and 9 to 12) makes it possible to stabilize a DMSO/methyl ester mixture at 0° C. and give a clear liquid with or without the presence of monopropylene glycol.

### EXAMPLE 2: COMPARATIVE EXAMPLE: STUDY OF THE BEHAVIOUR OF BINARY COMPOSITIONS OF THE THREE COMPONENTS OF THE COMPOSITION ACCORDING TO THE INVENTION

### Components:

The products used are:
DMSO (technical grade—Arkema)
Radia 7907 comprising at least 85% by mass of glyceryl caprylate (CAS No. 26402-26-6).
Mixture of C₆-C₁₀ methyl esters (CAS No. 68937-83-7), marketed under the reference RADIA™ 7983 by OLEON.
Mixture of coconut oil methyl esters (CAS No. 61788-59-8), or methyl cocoate, marketed under the reference RADIA™ 7112 by OLEON.
PKOGM

TABLE III
Proportions of the components as a percentage
by mass of the total weight of the composition

| Compositions | 13 | 14 | 15 | 16 | 17 | 18 |
|---|---|---|---|---|---|---|
| DMSO | 50% | | | 50.0% | | |
| C₆/C₁₀ | | 50% | | | 50.0% | |
| Methyl esters | | | | | | |
| Radia 7907 (incl. | 50% | 50% | 50.0% | | | |
| Glyceryl caprylate) | | | | | | |
| Methyl cocoate | | | 50.0% | | | 50.0% |
| PKOGM | | | | 50.0% | 50.0% | 50.0% |

The equipment used is:
15 mL flasks
A refrigerated cabinet at 0° C. (Panasonic—MR-154-PE)
3 mL pipettes
An analytical balance (OHAUS Adventurer Pro AV264C)

### Procedure

A 15 mL flask is placed on the analytical balance, each component is added in the proportions indicated. The synthesis is repeated in order to obtain a total of 3 samples of 10 g of compositions.

For composition 13, 5 g of DMSO and 5 g of RADIA™ 7907 are added to the flask.

For composition 14, 5 g of RADIA™ 7983 and 5 g of RADIA™ 7907 are added to the flask.

For composition 15, 5 g of RADIA™ 7112 and 5 g of RADIA™ 7907 are added to the flask.

For composition 16, 5 g of DMSO and 5 g of pa PKOGM added to the flask.

For composition 17, 5 g of RADIA™ 7983 and 5 g of PKOGM are added to the flask.

For composition 18, 5 g of RADIA™ 7112 and 5 g of PKOGM are added to the flask.

For each composition the flask is closed and agitated by hand for several seconds in order to obtain a homogenous mixture. According to the recommendations of standards CIPAC MT39 relating to the stability of phytosanitary products at 0° C., one of the flasks synthesized for each composition is then placed in the refrigerated cabinet at 0° C., and another is placed at ambient temperature. After 7 days' rest, the flasks are inspected and the results given in Table IV.

TABLE IV

| Compositions | 13 | 14 | 15 | 16 | 17 | 18 |
|---|---|---|---|---|---|---|
| Appearance at | Clear | Clear | Clear | Clear | Clear | Clear |
| ambient T ° | liquid | liquid | liquid | liquid | liquid | liquid |
| Appearance | solid | solid | solid | solid | solid | solid |
| at 0° C. | | | | | | |

### Results

The binary compositions are liquid at ambient temperature but crystallize at 0° C. Unexpectedly, as seen above, the mixture of the three components makes it possible to obtain a composition that is liquid at 0° C.

### EXAMPLE 3: COMPARATIVE STUDY OF THE COMPOSITIONS ACCORDING TO THE INVENTION AND OTHER DISPERSANT COMPOSITIONS, RHODIASOLV POLARCLEAN AND NMP

### Materials and Methods:

### Components:

The products used are:
DMSO (technical grade—Arkema)
Monopropylene glycol (RADIANOL™ 4713—OLEON)
Composition comprising at least 85% by mass of glyceryl caprylate (Radia™ 7907—OLEON)
Mixture of C₆/C₁₀ methyl esters (RADIA™ 7983—OLEON)
Mixture of coconut oil methyl esters (RADIA™ 7112—OLEON)
Diisoamyl succinate (OLEON)
Glyceryl caprylate/caprate (CAS No. 91052-46-9). This mixture is generally obtained by esterification of capric and caprylic acid with glycerol. The composition of this mixture is as follows:

### Glyceryl Caprylate/Caprate Composition:

| | % mass/total |
|---|---|
| | mass |
| glycerol | 2.3 |
| C6 monoglycerides | 0.1 |
| C8 monoglycerides | 69.8 |
| C10 monoglycerides | 22.9 |
| C8-C8 diglyceride | 3.2 |
| C8-C10 diglyceride | 1.3 |
| C10-C10 diglyceride | 0.1 |
| Other compounds | 0.3 |
| BALANCE | |
| glycerol | 2.3 |
| monoglycerides | 92.8 |
| diglycerides | 4.6 |
| triglycerides | 0.0 |

An ester amide, METHYL-5-(DIMETHYLAMINO)-2-METHYL-5-OXOPENTANOATE (CAS No. 1174627-68-9), marketed under the brand name Rhodiasolve Polarclean by RHODIA. There is between 70 and 90% of this compound.

TABLE V
Proportions of the components as a mass percentage with
respect to the total mass of the composition

| | Composition | | | | |
|---|---|---|---|---|---|
| | 19 | 20 | 21 | 22 | 23 |
| DMSO | 30.0% | 20.0% | 30.0% | 40.0% | 40.0% |
| Monopropylene glycol | | | | 10.0% | 5.0% |
| Radia 7983 | 15.0% | 20.0% | 30.0% | 30.0% | 30.0% |
| RADIA ™ 7907 | | 20.0% | 10% | 20.0% | 10.0% |
| 85% Glyceryl | | | | | |
| caprylate | | | | | |
| Methyl cocoate | 15.0% | 20.0% | 30.0% | | |
| Diisoamyl succinate | 20.0% | 20.0% | | | 15.0% |
| Glyceryl | 20.0% | | | | |
| caprylate/caprate | | | | | |

The equipment used is:
15 mL flasks
A refrigerated cabinet at 0° C. (Panasonic—MR-154-PE)
3 mL pipettes
An analytical balance (OHAUS Adventurer Pro AV264C)
A watch glass
A spatula
A tensiometer, brand name K100, sold by KRÜSS GmbH, Borsteler Chaussee 85, 22453 Hamburg, Germany.
A 70 mL crystallizing dish
A platinum blade
KRUSS laboratory software
A viscometer/densimeter SVM 3000—Anton Paar

### Procedure

For each composition, the 15 mL flask is placed on the analytical balance. Each component is added in the proportions indicated, in order to have 10 g of composition in total.

For composition 19, 3 g of DMSO, 1.5 g of RADIA™ 7983, 1.5 g of RADIA™ 7112, 2 g of diisoamyl succinate and 2 g of glyceryl caprylate/caprate are added to the flask.

For composition 20, 2 g of DMSO, 2 g of RADIA 7983™, 2 g of RADIA™ 7907, 2 g of RADIA 7112 and 2 g of diisoamyl succinate are added to the flask.

For composition 21, 3 g of DMSO, 3 g of RADIA™ 7983, 1 g of RADIA™ 7907 and 3 g of RADIA 7112 are added to the flask.

For composition 22, 4 g of DMSO, 1 g of RADIANOL™ 4713, 3 g of RADIA™ 7983 and 2 g of RADIA 7907 are added to the flask.

For composition 23, 4 g of DMSO, 0.5 g of RADIANOL™ 4713, 3 g of RADIA™ 7983, 1 g of RADIA 7907 and 1.5 g of diisoamyl succinate are added to the flask.

Once these additions have been carried out, each flask is closed and agitated by hand for several seconds in order to obtain a homogenous mixture. It is then placed in the refrigerated cabinet at 0° C. (CIPAC MT 39), a sample of 10 g of a product already on the market (Rhodiasolv Polarclean™) is also placed in the refrigerated cabinet at 0° C. After 7 days' rest, the flasks are inspected. A sample is also kept at ambient temperature and inspected after 7 days.

The compositions of formulae 19 to 23 and the dispersants of the prior art are tested for surface tension in order to find the wettability thereof, by using a fine plate (called a Wilhelmy plate) connected to an analytical balance. The method of the Wilhelmy blade on the K100 is used. A 70 mL crystallizing dish filled with 30 mL of product to be tested is placed in the K100. The platinum blade is arranged over the product. The KRUSS Laboratory software determines the surface tension of the liquid, via the force felt by the blade in the liquid. The viscosity and the density are also measured. The results are compiled in Table VI.

TABLE VI

| | Composition | | | | | | |
|---|---|---|---|---|---|---|---|
| | | | | | | Rhodia solv | |
| | | | | | | POLAR | |
| | 19 | 20 | 21 | 22 | 23 | CLEAN ™ | NMP |
| Appearance at | Clear | Clear | Clear | Clear | Clear | Clear | Clear |
| ambient T ° | liquid | liquid | liquid | liquid | liquid | liquid | liquid |
| Appearance | Clear | Clear | Clear | Clear | Clear | Clear | Clear |
| at 0° C. | liquid | liquid | liquid | liquid | liquid | liquid | liquid |
| Surface | 29.3 | 22.9 | 29.3 | 29.1 | 28.8 | 37.3 | 40 |
| tension at 20° C. | | | | | | | |
| (mN/m) | | | | | | | |
| Viscosity at 20° C. | 5.025 | 3.863 | 5.738 | 5.684 | 3.859 | 8.659 | 1.7 |
| (mm²/s) | | | | | | | |
| Density at 20° C. | 1.000 | 0.990 | 0.978 | 0.957 | 0.944 | 1.043 | 1.03 |
| (g/cm³)* | | | | | | | |
| Labelling* | / | / | / | / | / | H319 | H315/ |
| | | | | | | | H319/ |
| | | | | | | | H335/ |
| | | | | | | | H360D |

*in accordance with Regulation (EC) No. 1272/2008 for chemical products

Compositions 19, 20, 21, 22 and 23 and the products of the prior art are all liquid at 0° C. These products are compatible with solubilization tests for active ingredients. In addition, the surface tensions measured are lower for the compositions according to the invention than for the competitor products, which promotes satisfactory dispersion of powders in these liquids. The physico-chemical properties of the compositions according to the invention are comparable to the products already used for the solubilization of phytosanitary active ingredients. The use of diisoamyl succinate makes it possible to reduce the viscosity and to promote the solubilization of the active ingredients.

### EXAMPLE 4: SOLUBILIZING COMPOSITIONS OF TYPES 19 TO 21 COMPRISING AN ACTIVE INGREDIENT SOLUBILIZED ACCORDING TO THE INVENTION AND COMPARATIVE TESTS

The products used are:
DMSO (technical grade—Arkema)
Monopropylene glycol (RADIANOL™ 4713—OLEON)
RADIA™ 7907—OLEON; 85% by mass of glyceryl caprylate
Mixture of C₆/C₁₀ methyl esters (RADIA™ 7983—OLEON)
Coconut oil methyl esters (RADIA™ 7112—OLEON)
Diisoamyl succinate (OLEON)
Glyceryl caprylate/caprate (CAS No. 91052-46-9)
Clodinafop-propargyl: solid herbicide, purity >98%
Esteramide (Rhodiasolv Polarclean™—RHODIA)

The equipment used is:
15 mL and 60 mL flasks
A refrigerated cabinet at 0° C. (Panasonic—MR-154-PE)
3 mL pipettes
An analytical balance (OHAUS Adventurer Pro AV264C)
A watch glass
A spatula
A tensiometer, brand name K100, sold by KRÜSS GmbH, Borsteler (see above)
A 70 mL crystallizing dish
A platinum blade
KRUSS laboratory software
A viscometer/densimeter (see above)

### Method for Obtaining Composition 21

A composition 21 (see Example 3) according to the invention is prepared according to the following procedure: A 60 mL flask is placed on the analytical balance, each component is added in the proportions indicated in order to obtain 50 g of composition 21, i.e. 15 g of DMSO, 15 g of RADIA™ 7983, 15 g of RADIA™ 7112 and 5 g of RADIA 7907 are added to the flask. The latter is closed and agitated by hand for several seconds in order to obtain a homogenous mixture.

2.4 g of clodinafop-propargyl is weighed in a watch glass. 4 g of composition according to the invention or of Rhodiasolv Polarclean™ is then weighed in a 15 mL flask, the 2.4 g of clodinafop-propargyl is added using a metal spatula, the mass is adjusted to 10 g by adding either composition 21 or Rhodiasolv Polarclean™, as appropriate. Each flask is closed and agitated for several minutes in order to solubilize the active ingredient. The operation is repeated in order to prepare two flasks with the composition 21+the clodinafop-propargyl and two flasks with the Rhodiasolv Polarclean™+the clodinafop-propargyl. One flask of each is then placed at ambient temperature and the other in the refrigerated cabinet at 0° C. for 7 days. The flasks were inspected after 7 days' rest. Any presence of crystals in solution is sought for.

### Results:

The results are compiled in Table VII.

TABLE VII

| | Composition No. | |
|---|---|---|
| | | Rhodiasolv |
| | 21 | POLARCLEAN ™ |
| 24% of Clodinafop Propargyl | Clear liquid | Clear liquid |
| 7 days at ambient T° | | |
| 24% of Clodinafop Propargyl | Clear liquid | Clear liquid |
| 7 days at 0° C. | | |

No clodinafop-propargyl crystal is observed after 7 days at ambient temperature or at 0° C.

Method for Compositions 19 and 20 (Cf. Example 3).

A 60 mL flask is placed on the analytical balance, each component is added in the proportions indicated, in order to have 50 g of compositions 19 and 20 in total. For composition 19, 15 g of DMSO, 7.5 g of RADIA™ 7983, 7.5 g of RADIA™ 7112, 10 g of glyceryl caprylate/caprate and 10 g of diisoamyl succinate are added to a flask. For composition 20, 10 g of DMSO, 10 g of RADIA™ 7983, 10 g of RADIA™ 7112, 10 g of RADIA 7907 and 10 g of diisoamyl succinate are added to a flask. The flasks are then closed and agitated by hand for several seconds in order to obtain a homogenous mixture.

2.4 g of clodinafop-propargyl is weighed in a watch glass. 4 g of composition according to the invention 19 or 20 or of Rhodiasolv Polarclean™ is then weighed in a 15 mL flask, the 2.4 g of clodinafop-propargyl is added to the solvent using a metal spatula, the mass is adjusted to 10 g by adding composition 22, 23 or Rhodiasolv Polarclean™ according to the case. The flask is closed and agitated for several minutes in order to solubilize the active ingredient. The operation is repeated in order to prepare two flasks with each composition according to the invention+clodinafop-propargyl and two flasks with Rhodiasolv Polarclean™+clodinafop-propargyl. One flask of each is then placed at ambient temperature and the other in the refrigerated cabinet at 0° C. for 7 days. The flasks were inspected after 7 days' rest. The presence of crystals in solution is sought for.

### Results

The results are compiled in Table VIII

TABLE VIII

| | Composition No. | | |
|---|---|---|---|
| | | | Rhodiasolv |
| | 19 | 20 | POLARCLEAN ™ |
| 24% of Clodinafop Propargyl | Clear | Clear | Clear liquid |
| at 7 days at ambient T°. | liquid | liquid | |
| 24% of Clodinafop Propargyl | Clear | Clear | Clear liquid |
| at 7 days at 0° C. | liquid | liquid | |

No clodinafop-propargyl crystal is observed after 7 days at ambient temperature or at 0° C.

### EXAMPLE 5: USE OF A COMPOSITION ACCORDING TO THE INVENTION FOR SOLUBILIZING POLYURETHANE FOAM AND COMPARISON WITH THE USE OF NMP

The equipment used is:
A 500 mL crystallizing dish
A chronometer
Pieces of polyurethane foam (2.5×2.5×0.12 cm)
A Texture Analyzer 5 trade name TA1 from Lloyd Instruments

### Method:

4 pieces of polyurethane foam (PU) are immersed in a crystallizing dish containing 200 mL of composition 21 or NMP for 45 minutes. The pieces are then removed from the crystallizing dish and are placed on aluminium foil. The firmness of the pieces is then tested on the texture analyzer in compression mode.

By firmness is meant the force required for reaching a predefined deformation of the surface of the product tested. This force is expressed in Newtons (N). The firmness measurements were carried out by texture analysis. The test was carried out as follows for all the compositions and ingredients tested:

The texture analyzer was equipped with a cylindrical probe (diameter 12 mm, height 50 mm). A pre-stress of 0.2 N was applied at a velocity of 100 mm/s. The velocity of descent of the probe is 20 mm/sec and the penetration depth of the probe is 8 mm. This test is reproduced four times for each composition tested, each time with a different piece of foam. The average values of the maximum forces are then compared for each composition.

The firmness of the rigid polyurethane foam, tested under the same conditions as described above, is 43 N.

### Results:

The results are presented in Table IX below:

TABLE IX

| | Composition No. | |
|---|---|---|
| | 21 | NMP |
| Maximum force (N) | 0.22 +/− 0.06 | 0.20 +/− 0.06 |

The lower the force exerted by the probe, the less rigid the foam and the more the formulation will have degraded the foam. The composition 21 makes it possible to solubilize the PU foam as well as NMP. The composition 21 is a solvent that will behave in the same way as NMP in the field of cleaning polyurethane foams.

### EXAMPLE 6

A composition 22 according to the invention was obtained using the procedure described above. The composition 22 comprises 66% of Radia 7121 (C12/C14 methyl cocoate), 17% of DMSO and 7% of PKOGM.

The mixture obtained is homogenous and remains stable after the tests described above have been carried out at 0° C.

1. A composition comprising:
at least 25% of a methyl ester of a fatty acid having from 6 to 14 carbon atoms, or a mixture of such methyl esters;
at least 15% of dimethyl sulfoxide, or DMSO; and
at least 5% of a glyceryl monoester of a fatty acid having from 6 to 14 carbon atoms, or a mixture of such glyceryl monoesters;
the percentages being by mass with respect to the total mass of the composition.

2. The composition according to claim 1, in which the fatty acid of said methyl ester has from 8 to 12 carbon atoms.

3. The composition according to claim 1, in which the fatty acid of said glyceryl monoester has from 8 to 12 carbon atoms.

4. The composition according to claim 1, said composition comprising from 15 to 65% of DMSO.

5. The composition according to claim 1, said composition comprising from 25 to 80% of methyl ester(s).

6. The composition according to claim 1, said composition comprising from 10 to 30% of glyceryl monoester(s).

7. The composition according to claim 1, said composition further comprising from 0.01 to 30% by mass of monopropylene glycol and/or from 0.01 to 40% by mass of succinate ester(s).

8. An active composition comprising the composition according to claim 1, said active composition further comprising in solution a herbicide, a fungicide and/or an insecticide.

9. A method for dissolving an active compound comprising mixing a composition according to claim 1 with an active compound.

10. A method for cleaning or removing polyurethane foam comprising applying a composition according to claim 1 to a polyurethane foam.

11. A method for producing a composition according to claim 1, said method comprising mixing DMSO with said one or more fatty acid methyl ester(s) and said one or more fatty acid glyceryl monoester(s).

12. The composition according to claim 1, in which the fatty acid of said methyl ester has from 8 to 10 carbon atoms.

13. A method for producing an active composition according to claim 8, said method comprising mixing DMSO with said one or more fatty acid methyl ester(s) and said one or more fatty acid glyceryl monoester(s), and with an herbicide, a fungicide and/or an insecticide.
